(19) United States
(12) Patent Application Publication
(10) Pub. No.: US 2025/0226644 A1
(43) Pub. Date: Jul. 10, 2025

(54) WEATHERPROOF RECESSED OUTLET BOX

(71) Applicant: Hubbell Incorporated, Shelton, CT (US)

(72) Inventors: Jace Robert Lee Matteson, Granger, IN (US); Stephen Michael Boener, Goshen, IN (US); Jonathan Randall Falls, Gilbert, AZ (US)

(21) Appl. No.: 19/005,125

(22) Filed: Dec. 30, 2024

Related U.S. Application Data
(60) Provisional application No. 63/618,625, filed on Jan. 8, 2024.

(51) Int. Cl. H02G 3/12; H02G 3/08; H02G 3/14

(52) U.S. Cl. CPC H02G 3/12; H02G 3/085; H02G 3/088; H02G 3/14

(57) ABSTRACT

A recessed outlet housing includes an outlet box having a plurality of first side walls, a rear wall, and an open front configured to receive an electrical device. A mounting flange extends from the outlet box. The mounting flange comprising a plurality of cells. A base extends from the outlet box. The base has a plurality of second side walls. The base is configured to receive a lid.

### FIELD

Various exemplary embodiments relate to an electrical box and cover assembly that can be used in outdoor installations.

### BACKGROUND

Electrical boxes are known for receiving electrical wiring for various wiring devices. The electrical boxes can stand alone or can be recessed in a wall, ceiling, floor, or other surface.

Electrical devices such as, but not limited to, electrical outlets, switches, and others are typically installed in a wall or ceiling. In indoor applications, an electrical box, also referred to as a gang or junction box, is secured to a stud or support beam inside of the wall or ceiling. In outdoor applications, the electrical box can be installed in an opening or recess formed in an outer wall. After the box is mounted, an electrical device is secured in the box in electrical communication with one or more electrical conductors. In this manner, any exposed portion of the electrical conductor and its connection to the electrical device can be shielded within the box.

In most applications, exterior electrical boxes and switches require a cover to protect the electrical device from the rain and other elements. Although building codes may vary between areas, most codes require the cover to be self-closing so that cover will automatically close around the electrical device when released. The cover is either spring biased or gravity operated.

One common type of outdoor cover is a flat metal cover that includes a spring biased metal plate that is hingedly connected to a base of the outlet cover. The metal plate pivots from a closed position covering and tightly sealing the plug receptacles to an open position allowing access to the receptacles. In some cases, an electrical outlet includes a single plate with a number of plug receptacles disposed therein. In other cases, a plurality of hinged plates are provided, with each plate corresponding to a different one of the receptacles to permit each receptacle to be covered and uncovered independently.

A major problem with flat electrical outlet covers is that the hinged lids provide protection only while the receptacles are not in use. As soon as a lid is swung open to allow an electrical appliance to be plugged into a receptacle, that receptacle is open to the elements and vulnerable to damage from moisture and the like.

Some solutions provide a cover for the electrical device that can be used while an electrical plug, wire or the like is connected to the electrical outlet where the cover can close over the plug or wire without interfering with the cover. Many different cover designs seek to shield the devices from weather-related contaminants while electrical connectors are coupled with the devices. These cover designs are generally called “in-use” covers.

### SUMMARY

Certain implementations are directed to a mounting flange for an outlet housing, the mounting flange including one or more cells.

In certain configurations, a recessed outlet housing includes an outlet box having a plurality of first side walls, a rear wall, and an open front configured to receive an electrical device. A mounting flange extends from the outlet box. The mounting flange comprising a plurality of cells. A base extends from the outlet box. The base has a plurality of second side walls. The base is configured to receive a lid.

In certain configurations, a recessed outlet housing includes an outlet box having a plurality of first side walls, a rear wall, and an open front configured to receive an electrical device. A mounting flange extends from the outlet box. The mounting flange comprising a plurality of cells. A base extends from the outlet box. The base has a plurality of second side walls. A lid is removably connected to the base.

In certain configurations, a recessed outlet housing includes an outlet box having a plurality of first side walls, a rear wall, and an open front configured to receive an electrical device. A mounting flange extends from the outlet box. A base extends from the outlet box. The base has a plurality of second side walls. The base is configured to receive a lid. A siding flange is removably connected to the base.

In certain configurations, a recessed outlet housing includes an outlet box having a plurality of first side walls, a rear wall, and an open front configured to receive an electrical device. A mounting flange extends from the outlet box. A base extends from the outlet box. The base has a plurality of second side walls. The base is configured to receive a lid. A cable groove is formed in at least one of the second side walls.

In certain configurations, a recessed outlet housing includes an outlet box having a plurality of first side walls, a rear wall, and an open front configured to receive an electrical device. A mounting flange extends from the outlet box. A base extends from the outlet box. The base has a plurality of second side walls. The base is configured to receive a lid. A cable groove is formed in at least one of the second side walls. A barrier channel extends into the cable groove.

Certain implementations are directed to a method of installing a recessed outlet housing. A recessed outlet housing is inserted into an opening in a wall. The recessed outlet housing has an outlet box, a mounting flange having a plurality of closed cells and a plurality of open cells, and a base. The mounting flange is positioned adjacent to the wall. A mounting material is applied to the mounting flange to spread the mounting material over a first closed cell and through a first open cell. An electrical device is connected to the outlet box. A lid is connected to the base.

### BRIEF DESCRIPTION OF THE DRAWINGS

The aspects and features of various exemplary embodiments will be more apparent from the description of those exemplary embodiments taken with reference to the accompanying drawings.

FIG. 1 is a front perspective view of an outlet housing.

FIG. 2 is a rear perspective view of the outlet housing of FIG. 1.

FIG. 3 is a front view of the outlet housing of FIG. 1.

FIG. 4 is a right side view of the outlet housing of FIG. 1.

FIG. 5 is a rear perspective view of a lid.

FIG. 6 is a front perspective view of the outlet housing of FIG. 1 with a hinged pin and spring attached.

FIG. 7 is a front perspective view of the outlet housing of FIG. 1 with the lid attached.

FIG. 8 is a front perspective view of a siding flange.

FIG. 9 is a rear perspective view of the siding flange of FIG. 8.

FIG. 10 is a front view of the housing of FIG. 1 with the lid and siding flange.

FIG. 11 is a side view of the housing of FIG. 1 with the lid and siding flange attached.

FIG. 12 is a front perspective view of another outlet housing.

FIG. 13 is a partial view of the base of the outlet housing of FIG. 12.

FIG. 14 is a perspective view of a barrier.

FIG. 15 is a partial view of the barrier positioned in the base of FIG. 12.

FIG. 16 is a perspective view of another siding flange.

FIG. 17 is a partial view of the siding flange connected to the outlet housing of FIG. 12.

### DETAILED DESCRIPTION OF EXEMPLARY EMBODIMENTS

Various exemplary configurations are disclosed for a weatherproof outlet housing having an electrical box and cover. Outlet boxes are primarily used to protect the wiring connections and facilitate the installation of outlets, switches, or other devices. Outdoor electrical outlets need to be housed in a weatherproof assembly that meets or exceeds standard local building codes and standards set by national bodies such as Underwriter Laboratories (UL) and the National Electrical Code (NEC).

In certain implementations, an outlet cover can be configured as a weatherproof in-use outlet cover. In-use outlet covers can be configured to allow an electrical plug to be plugged into the outlet while a protective cover is closed. Having the cover closed while being used allows the cover to protect the outlet from the elements, such as rain, moisture and dust. These covers can have a fixed interior dimension or an adjustable dimension. Adjustability can be made possible, in particular implementations, through the use of two or more telescoping sections that extend to one or more in-use positions when it is desired to use the outlet while the cover is closed, and retract to a storage position when there is no need to have the cover closed with a plug inserted.

Weatherproof outlet covers can include a housing formed by a base and a moveable lid which cover the outlet from external exposure. When closed, the covers can resist water from reaching the electrical device or outlet sufficient to meet and pass the testing standards, for example those established by UL. Weatherproof covers can be designed for either horizontal or vertical mounting depending on the desires of the end user.

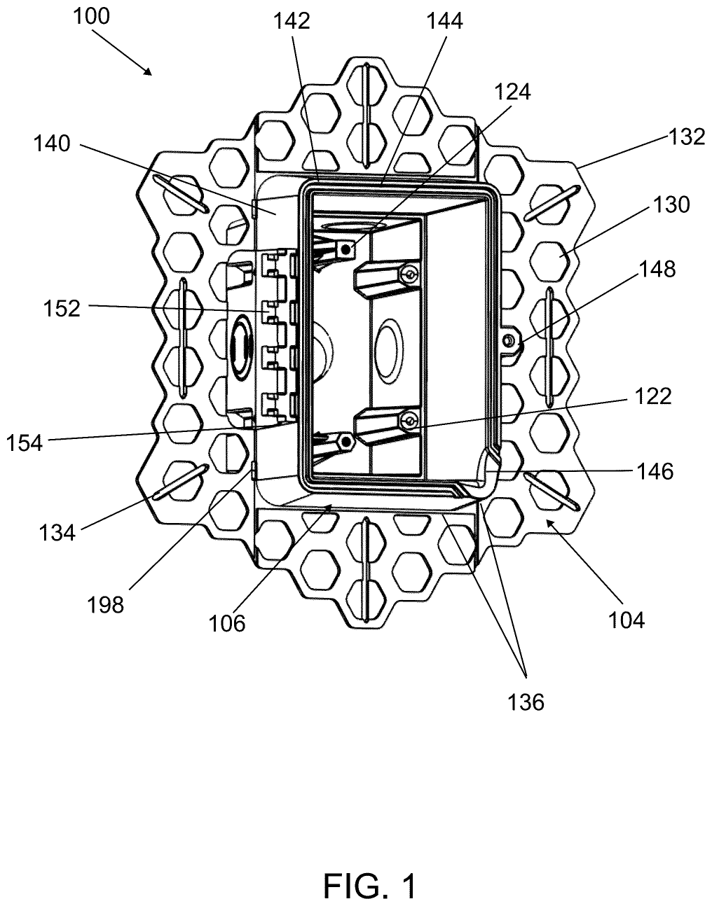

FIGS. 1-3 show an exemplary configuration of an outlet housing 100 having an integrated outlet box 102, mounting flange 104, and base 106 to receive a cover. The outlet box 102 and the base 106 are separated by the mounting flange 104.

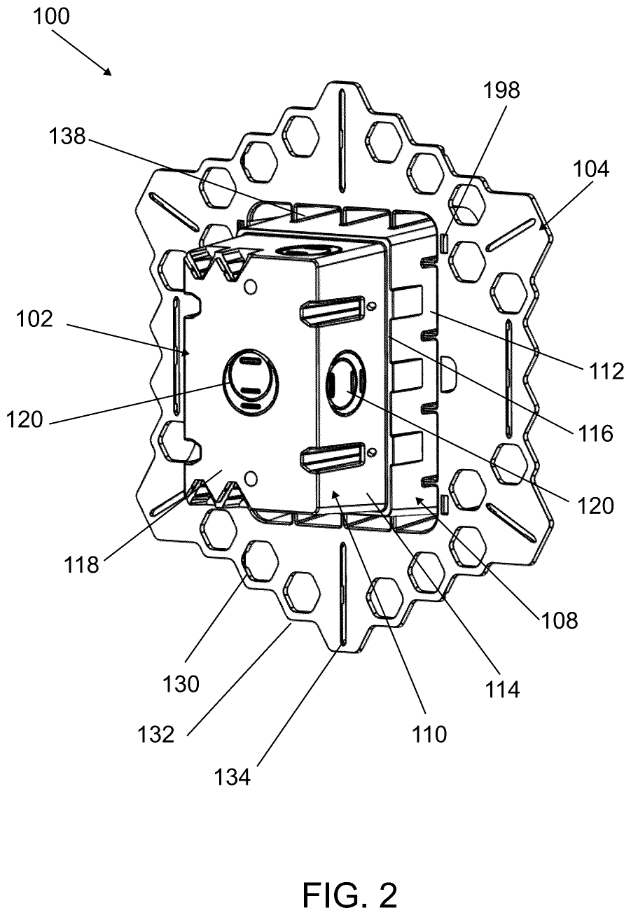

As best shown in FIG. 2, the outlet box 102 includes a front portion 108 extending from the mounting flange 104 and a rear portion 110 extending from the front portion 108. The front portion 108 and the rear portion 110 can each be angled inwardly toward a central axis of the outlet box 102 from the front toward the rear to provide a truncated rectangular pyramid configuration. Other shapes and configurations can also be used.

For example, the outlet box 102 can be various sizes and shapes to accommodate different wiring needs. Larger boxes are used when more wiring connections are required or when accommodating larger devices. Common shapes include square, rectangular, and round. Square and rectangular boxes are common for outlets and switches, while round boxes are often used for ceiling fixtures. The chosen shape depends on the specific electrical components being installed. The size is chosen based on the number of wires and devices that need to be accommodated.

The outlet box 102 is configured to receive an electrical device. Typical configurations for electrical devices include, but are not limited to, blank, duplex, decora, ground fault circuit interrupt (GFCI), round and switch. The outlet box 102 can be configured for use with a duplex electrical outlet, it may alternatively be configured, directly or through the use of removable tabs or adapter plates, for use with a different electrical device such as, and without limitation, an electrical switch, a GFCI outlet, a round outlet, an electrical cable, multiple electrical devices, and the like.

The front portion 108 includes a plurality of first side walls 112 and the rear portion 110 includes a plurality of second side walls 114. The side walls can be oriented in different directions depending on if a vertical or horizontal positioning of the outlet box 102 is desired. The front portion side walls 112 can be set wider than the rear portion side walls 114 so that a rear edge 116 bounds the front portion 108 and the rear portion 110.

The rear portion 110 includes a rear wall 118 that forms the back of the outlet box 102. The rear wall 118 and the side walls 114 define an interior for receiving the electrical device such as an outlet or a switch. The depth of the outlet box 102 can depend on the number of wires and the type of devices to be installed. Deeper boxes provide more space for wiring connections and are suitable for accommodating larger devices or multiple wires.

The sides 114 and rear 118 of the rear portion 110 can include knockouts 120 or perforated areas that can be removed to create openings for wiring or conduits. This allows for flexibility in routing wires or conduits into and out of the box 102. This feature allows electricians to customize the box 102 according to the specific wiring requirements.

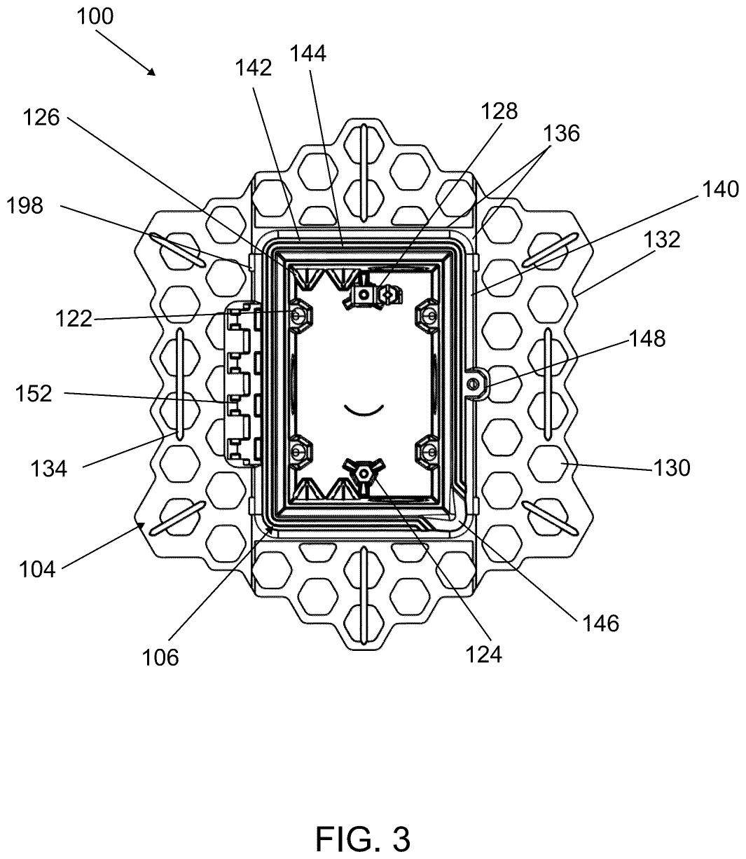

As best shown in FIGS. 1 and 3, the interior of the outlet box 102 can include one or more mounting features to assist in mounting the outlet box 102 to a structure and to assist in mounting an electrical device to the outlet box 102. A first set of mounting bosses 122 can be positioned adjacent to the outer wall to receive fasteners to optionally secure the outlet box 102 to a support structure. For example, fasteners can be driving through the first set of mounting bosses 122 to connect the outlet box to a support such as a concrete block. The first set of mounting bosses 122 can extend from the front opening of the outlet box to the rear wall. In the illustrated configuration, two of the first mounting bosses 122 are positioned on opposing sides of the outlet housing.

A second set of mounting bosses 124 can be positioned inside of the interior to receive fasteners to secure an electrical device, such as an outlet or switch. In the illustrated embodiment, two of the second mounting bosses 124 are provided with one on the top and the other on the bottom. Each of the first and second mounting bosses 122, 124 can be provided with ribs extending from the bosses to the rear wall or side walls to provide support.

One or more rear projections 126 can be provided which extend into the interior of the outlet box 102. The rear projections 126 can have a triangular configuration with moveable cantilevered walls. The rear projections 126 can be configured to receive a cable, such as a Romex style sheathed cable that can be pushed through openings in the projections that deflect and hold the cable once attached.

Various other components can be associated with the box as needed. For example, grounding screws can be provided within the outlet box to connect the grounding conductor, ensuring that the entire electrical system is properly grounded. Grounding is crucial for safety, as it helps prevent electrical shocks and reduces the risk of fire. FIG. 3, shows a grounding strap 128 connected to one of the second mounting bosses 124. The grounding strap can be snap-fit to the second mounting boss 124 and secured between the mounting boss and the electrical device and provide a grounding fastener connection for the electrical device.

On the exterior of the box, cable clamps can be used for strain relief and to secure incoming and outgoing electrical cables. The cable clamps can prevent or reduce over tension of cables and reduce the risk of an inadvertent disconnection.

In certain configurations the housing includes a mounting flange 104. The mounting flange 104 is used to assist in securing the outlet housing to a support structure, for example a wall. During installation the mounting flange 104 can be secured to a wall with one or more fasteners and a mounting material, for example concrete or stucco, mortar, etc., can be applied over the mounting flange.

The mounting flange 104 extends from the outlet box 102 and base 106. The interior of the mounting flange 104 includes a plurality of cells 130. The cells 130 can be various sizes and shapes and can at least partially define an outer edge 132 and overall footprint of the mounting flange 104. The cells 130 are non-adjoining, spaced from each other by a thickness that can be adjusted as needed. In other configurations the cells 130 can be adjoining. The cells 130 can be curvilinear or rectilinear shapes.

In the illustrated embodiment, the mounting flange 104 has a honeycomb configuration that includes a plurality of hexagonal cells 130. The outer edge 132 of the mounting flange 104 can be staggered corresponding to the interior cells 130 and the number of cells 130 in each row can be varied. In the illustrated configuration, the cells 130 are positioned to provide extensions at the corner regions and along the central axis to provide a substantially hexagonal overall footprint. Other shapes and sizes can be used for the cells 130, the outer edge 132, and the overall footprint of the device. Although the illustrated embodiments show substantially uniform cells 130, one or more cells 130 can have different configurations than the others.

Slots 134 can be provided in the flange 104, extending through one or more of the cells 130. The slots 134 are configured to receive a fastener to assist in securing the mounting flange 104 to a support surface such as a wall. The slots 134 allow the position of the fasteners to be adjusted as needed. Other embodiments can utilize round openings in different positions in conjunction with or instead of the slots 134 as shown.

In certain configurations, a plurality of the cells 130 are open and a plurality of the cells 130 are closed. The open cells 130 help increase adhesion to a mounting material, such as stucco. The material is able to flow or be pushed through the openings to increase the contact surface area between the mounting material and the mounting flange 104. The closed cells 130 help increase the structural integrity and support of the mounting flange 104. In the illustrated embodiment, cells 130 adjacent the outer edge 132 between the corners and along a central axis can be open while the remaining cells 130 are closed. Cells 130 that include a mounting slot 134 can be closed to provide more support for the received fastener.

In certain configurations, one or more score lines 136 can be formed in the mounting flange 104. In the illustrated embodiment, score lines 136 extend along at least a portion of each side of the mounting flange 104 positioned adjacent to the base 106. The score lines 136 allow the mounting flange 104 to be optionally removed if not needed so that the housing 100 can be mounted to a support structure without the use of the mounting flange 104. The score lines 136 can be configured to allow removal by hand or by use of a tool such as a utility knife.

As best shown in FIG. 2, a plurality of angled ribs 138 extend from the flange 104 and the base 106 to connect to the outlet box 102. The ribs 138 extend forward on the interior of the base 106 to provide support for the base 106 and the mounting flange 104.

As shown in FIGS. 1 and 3, the base 106 extends from the mounting flange 104 and the outlet box 102. The base 106 includes a plurality of sidewalls 140 that at least partially define an interior. A front edge 142 of the base can include a channel 144 for receiving a gasket or a portion of a lid. The exterior of the base 106 can be angled inwardly toward a central axis of the base 106 from the mounting flange 104 to the front edge 140 to provide a truncated rectangular pyramid configuration.

The base 106 can provide an in-use housing for an outlet, and can have a depth sufficient to receive one or more plugs and the associated cords connected to the outlet. A portion of the front edge 142 can include a recessed groove 146 that allows one or more cords to pass outside of the housing when a lid is in a closed position. The depth of the base 106 can be adjusted as needed, and can be made smaller for non in-use applications.

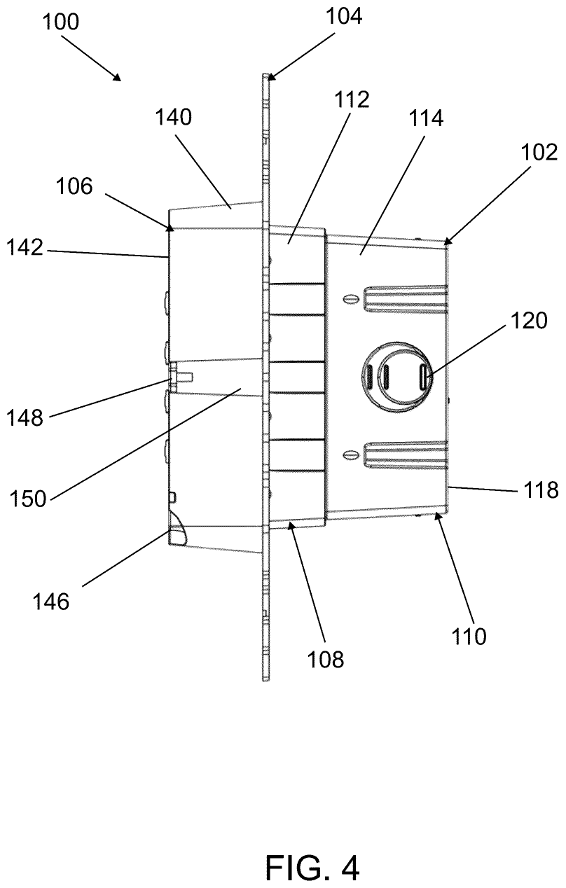

A first side of the base 106 can include a latch member 148. The latch member 148 can have a body that extends from a side of the base 106. The latch member 148 can also include an opening in the body configured to optionally receive a lock to prevent unauthorized access to the housing 100. As best shown in FIG. 4, a first ramp 150 extends from the latch member 148 along the side of the base 106. The first ramp 150 tapers from the latch member 148 in the direction of the mounting flange 104 corresponding with the angle of the base 106 side wall 140. This can provide a substantially uniform outer width at this section of the base 106, provide reinforcement for the latch member 148, and can also assist in forming the base 106 in certain molding operations. The mounting flange 104 can include an optional opening adjacent the first ramp 150 that can also assist in forming the housing as a single piece in certain molding operations.

As best shown in FIGS. 1 and 3, a second side of the base 106 can include a hinge member 152. The hinge member 152 can include one or more bearing surfaces configured to rotatably receive a hinge pin to mount the lid. Other conventional mounting structures can be used. A second ramp 154 extends from the hinge member 152 along the side of the base 106. The second ramp 154 tapers from the hinge member 152 in the direction of the mounting flange 104 corresponding with the angle of the base side wall 140. This can provide a substantially uniform outer width at this section of the base 106, provide reinforcement for the hinge member 152, and can also assist in forming the base 106 in certain molding operations. The mounting flange 104 can include an optional opening adjacent the second ramp 154 that can also assist in forming the housing as a single piece in certain molding operations.

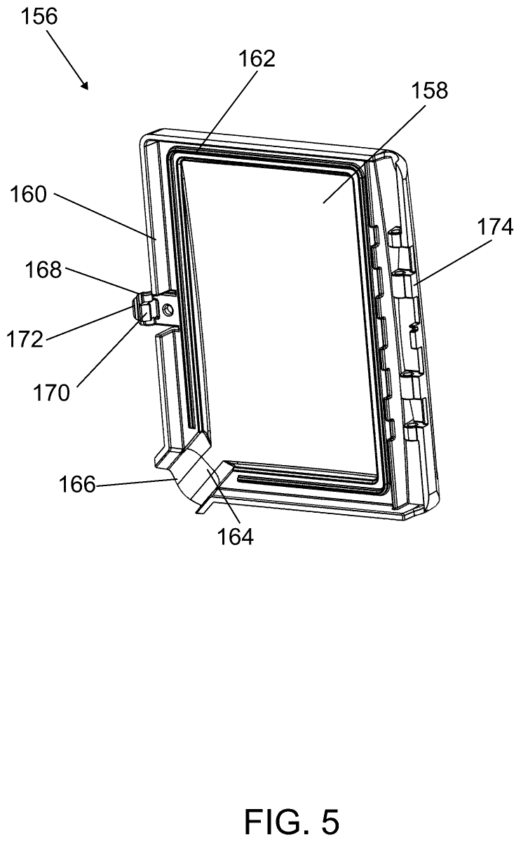

FIG. 5 shows the interior of an exemplary lid 156 that can be connected to the base 106. The lid 156 includes a front wall 158 and a plurality of side walls 160. The front wall 158 is shown with a slight curve with minimal extension to provide a flat or flush lid configuration as opposed to a pop-out or bubble lid configuration.

A flat style lid can also be used with a gasket associated with the lid so that when the lid is closed against the base, the gasket contacts the base to resist water flow to the electrical components. Flat lids are generally smaller and of lighter weight than those of bubble lids which can be closed by gravity. Because of the thin profile of a flat lid, some form of a spring or other biasing device can be used to force the lid closed to press and maintain the gasket against the base. Without the spring, the lighter lids are subject to being blown open by the wind or to remaining slightly open thereby exposing the electrical outlet to the weather.

A bubble style lid can be used to provide an in-use weather proof cover. A bubble style lid is designed with interior space to receive a plug and a portion of the cord. An exit is typically provided for the cord so that the lid can be closed while the plug remains inserted. For additional weatherproofing protection, a portion of the lid can overlap a portion of the base.

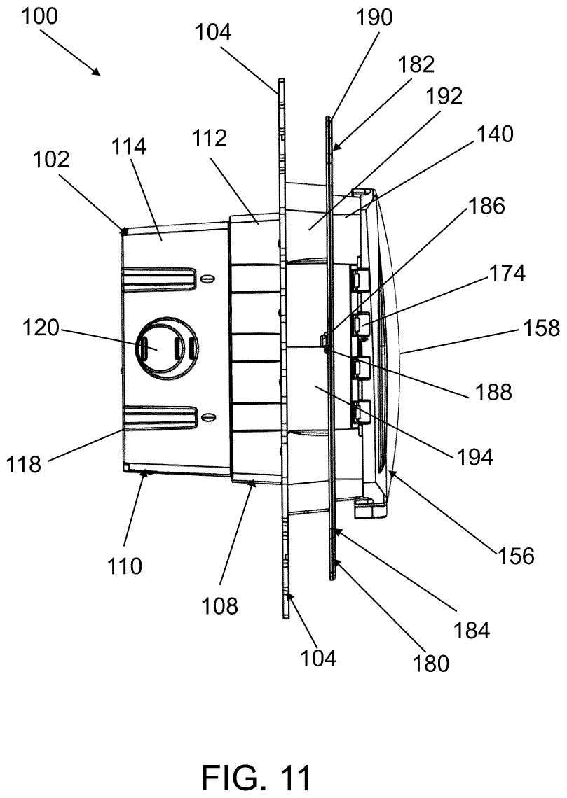

The interior of the lid 156 can include a projection 162 that is configured to align with the channel 144 on the base 106. The projection 162 can extend into the channel 144 as best shown in FIG. 11 and a gasket can be positioned between the projection and the base of the channel 144 if needed. A groove 164 is provided on the interior of the lid 156 to align with the cord groove 146 on the base 106. A curved extension 166 can be formed around the groove 164 to help provide a covered passage for the cord.

A lid latch member 168 is formed on one side of the lid 156. The lid latch member 168 can include a cantilever hook portion 170 configured to form a snap-fit engagement with the base latch member 148. A tab 172 can extend from the hook portion 170 to assist a user in deflecting the hook portion 170 to disengage the lid latch member 168. An opening can be provided in the lid latch member 168 to align with the opening on the base latch member 148.

A lid hinge member 174 is formed on the side of the lid 156 opposite the lid latch member 168. The hinge member 174 can include a plurality of bearing surfaces with openings aligned with the base hinge member 152 to receive a hinge pin.

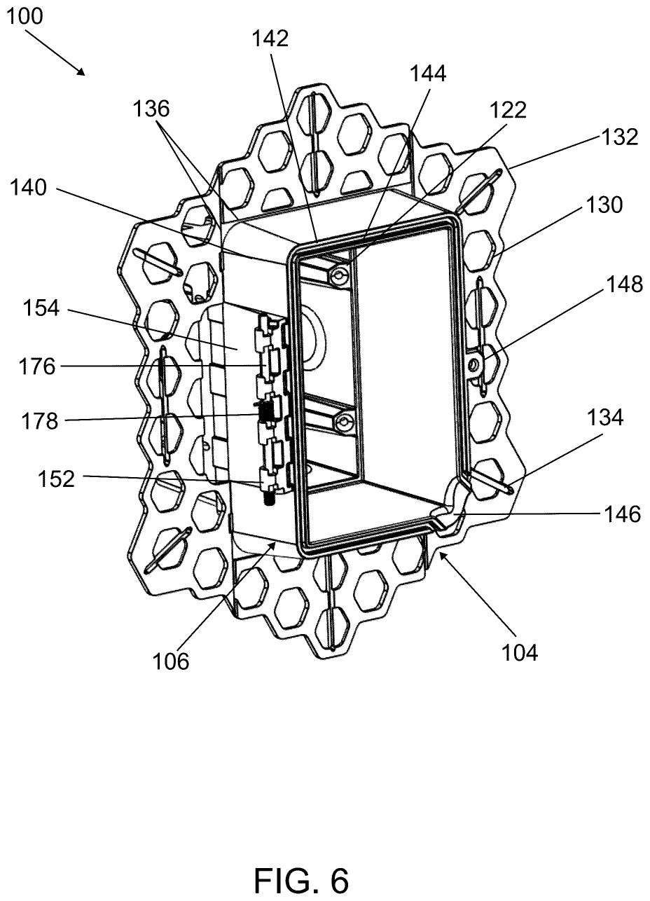

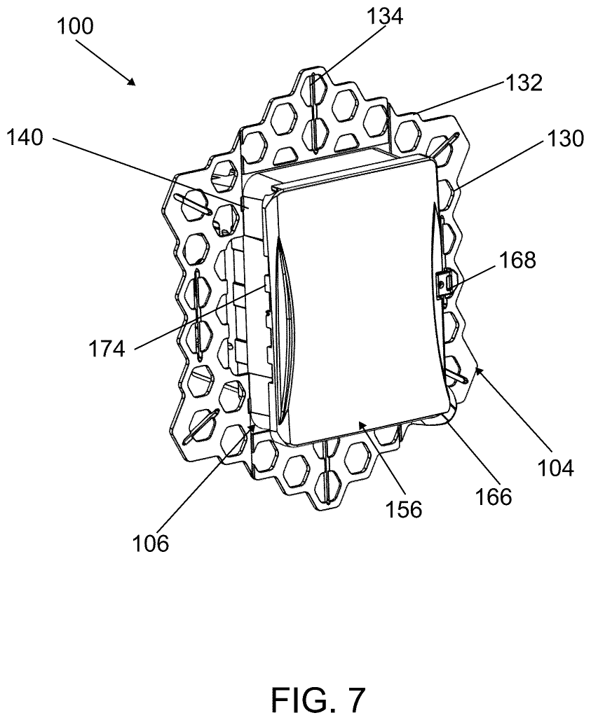

FIG. 6 shows a hinge pin 176 and a spring 178 received in the base hinge member 152 and FIG. 7 shows the lid 156 connected to the base 106. The spring 178 can bias the lid 156 to the closed position as required by code in certain locations. Other configurations can utilize a weighted lid that is configured to sufficiently close with gravity in either a horizontal or vertical orientation.

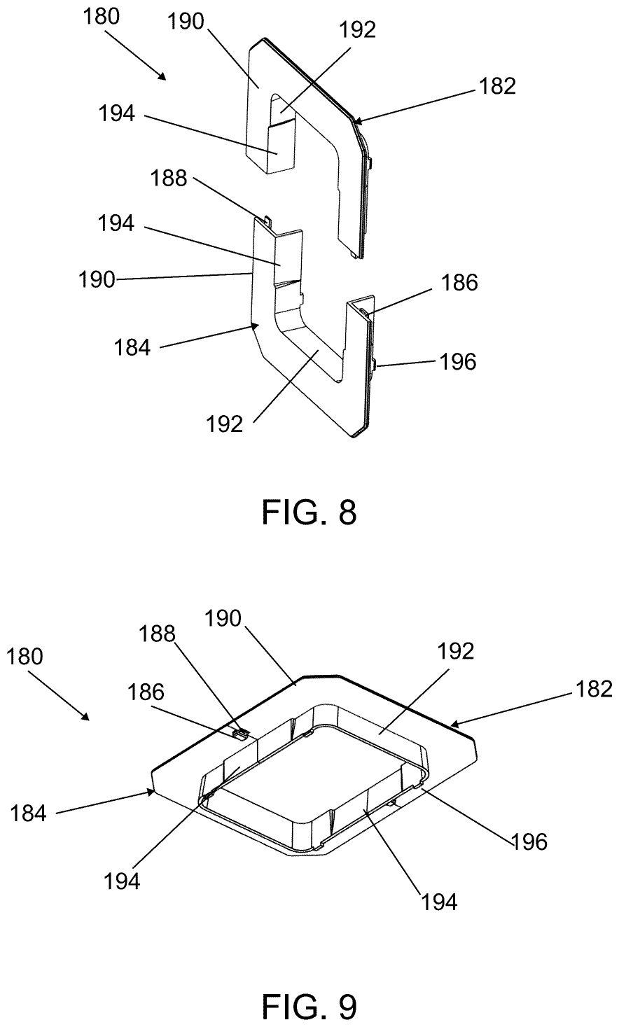

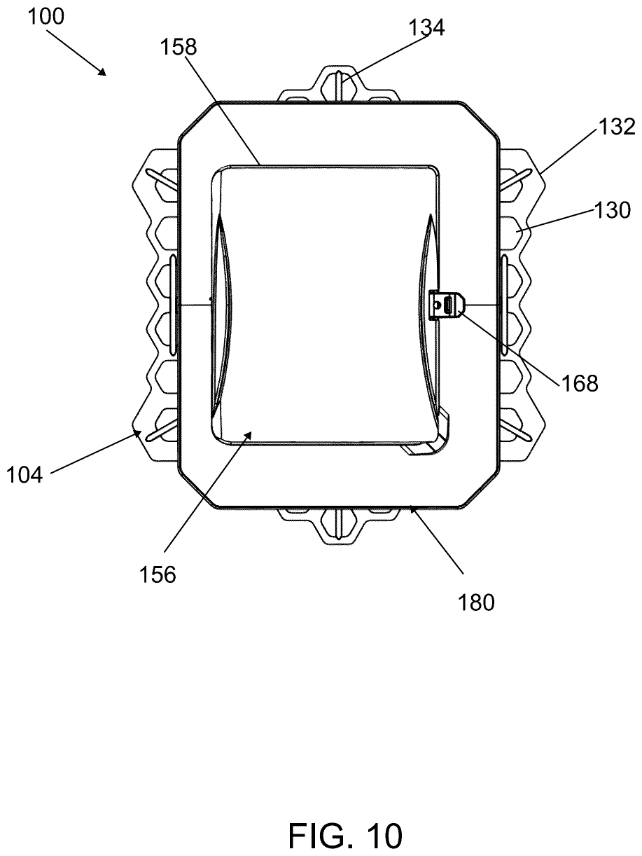

FIGS. 8 and 9 show an example of a siding flange 180 that can optionally be used with the housing 100. The siding flange 180 can be slidably engaged around the base 106 to provide a more flush appearance with siding on a wall.

In an exemplary configuration, the siding flange 180 can include a first piece 182 and a second piece 184 that are releasably connected together. In certain configurations, the first and second pieces 182, 184 are identical and can be mated with a like piece so that only a single part needs to be molded to create the two-piece flange. Each of the first and second pieces 182, 184 can include a slot 186 on one side and a tab 188 on the other. The slot 186 and the tab 188 are configured to mate with a corresponding slot 186 and the tab 188 on the opposite piece. The tab 188 slidingly engages the slot 186 to align the two pieces. Other mating connection features may also be used.

During installation the first piece 182 can slide around the base 106 from the top or a first side depending on the orientation and the second piece 184 can slide around the bottom or opposite side. The tabs 188 and slots 186 can be mated to engage the first and second pieces 182, 184 around the base 106.

The combined siding flange 180 includes a first portion 190 extending in a first direction away from the outer walls 140 of the base 106. The first portion 190 includes an inner surface that is configured to face the support structure, such as a wall, and outer surface that is configured to face outwardly toward a user. The outer surface can be textured or colored as desired to match different types of housing sidings.

The siding flange 180 includes a second portion 192 extending in a second direction away from the first portion 190. The second portion can be configured to be angled to correspond to the outer wall 140 of the base 106. An inner area 194 on both sides of the second portion 192 can include an angled wall that aligns with and corresponds to the first ramp 150 and second ramp 154 on the base 106. The size of both the inner areas 194 can be configured to mate with the second ramp 154 so that the siding flange 180 can be oriented in either direction on the base 106. The angled inner area 194 allows a substantially uniform bottom edge for the siding flange 180.

In certain configurations one or more mounting tabs 196 extend from the second portion 192 of the siding flange 180. The mounting tabs 196 can include a snap-fit configuration, such as a cantilever hook member designed to deflect and mate with slots 198 on the mounting flange 104 (shown in FIGS. 1-3). During installation, after the first and second pieces 182, 184 are mated, the siding flange 180 can be pushed into the mounting flange 104 so that the mounting tabs 196 mate with the slots 198.

In certain implementations the housing 100 can be installed in a support structure, such as a stucco wall. During installation, a proper location can be selected for the housing 100, giving consideration to convenience, proximity to power supply conductors, necessary electrical code, and the structural integrity of the wall. An opening can be formed in the wall, for example by drilling, sawing, or a combination thereof. Any necessary knockouts 120 can be removed and conductors or cables can be run into the interior of the outlet box 102 or placed in communication with the interior as needed. The housing 100 can then be placed in the opening so that the outlet box 102 extends into the wall and the mounting flange 104 is engaged with the wall. Mounting fasteners can be used, for example in the interior of the outlet box 102 through mounting bosses 122, through one or more of the mounting slots 134, or any combination thereof. Mounting material, in this example stucco, although mortar or other materials may be used depending on the exterior surface, is applied over the mounting flange 104 and left to harden. In some installations, the lid 156 is attached to the base 106 and any finishing operations can be performed, and installation completed. For example, a protective film can be removed from to the lid 156 or other parts of the assembly. In certain installations, the lid 156 can be mounted to the base separately after the installation procedure is completed.

In certain installations, after the base 106 is installed the optional siding flange 180 can be connected over the base 106. The siding flange 180 may be used in installations where a mounting material, such as stucco is not used, and therefore the base 106 is installed using mounting fasteners which are embedded in a support structure.

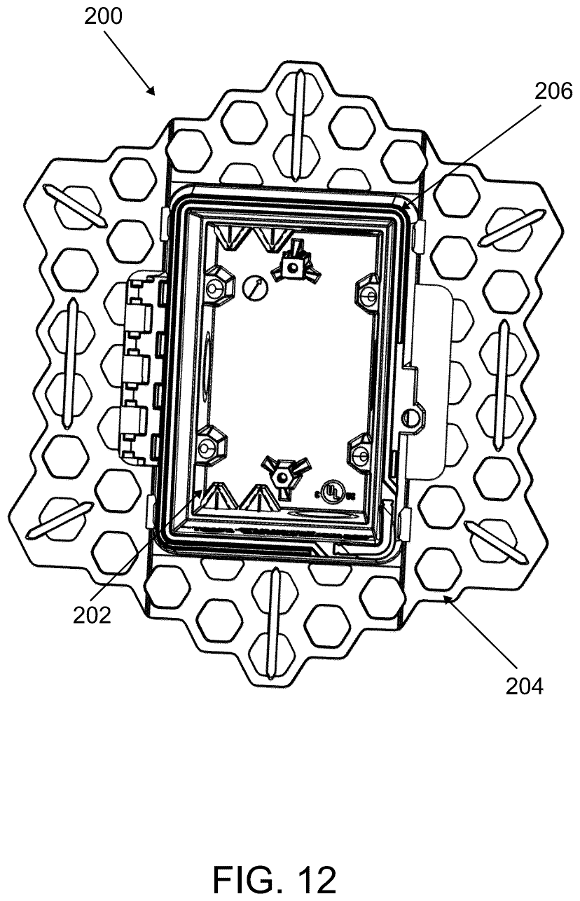

FIG. 12 shows an exemplary configuration of the outlet housing 100 having a one or more reinforcement members 109 extending along the side walls 112 of the front portion 108 and the side walls 114 of the rear portion 110 of the outlet box 102. The illustrated configuration shows two reinforcement members 109, each extending from a corresponding angled rib 138 along the side walls 112, 114. Corresponding reinforcement members 109 are similar formed on the opposite side of the outlet box 102. In other configurations, fewer or more reinforcement members 109 can be used and the position of the reinforcement members can be adjusted.

In certain implementations, if the mounting flange 104 is removed, and the outlet box 102 is secured to a structure using fasteners, the fasteners can go through the side walls 112, 114 of the outlet box 102 at an angle. This can result in a twisting force on the box due to the torque created. The reinforcement members 109 resist the twisting force created by this torque and can help prevent deformation of the sidewalls 112, 114.

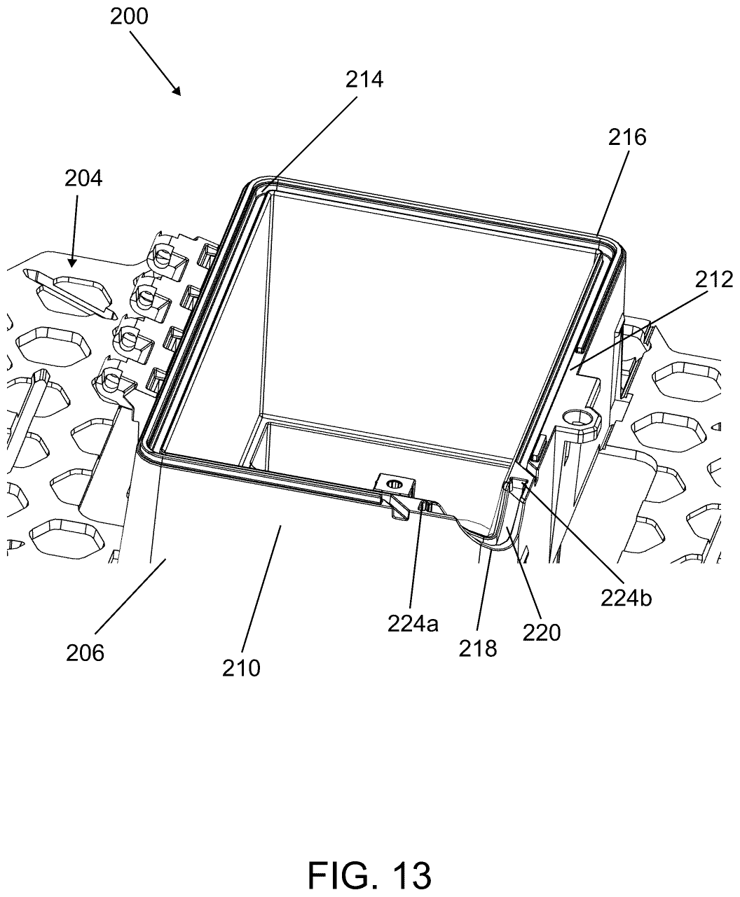

FIGS. 12 and 13 show an exemplary configuration of an outlet housing 200 having an integrated outlet box 202, mounting flange 204, and base 206 to receive a cover. The outlet box 202 and the base 206 are separated by the mounting flange 204. The outlet box 202, mounting flange 204, and base 206 can have any combination of features to those described herein. Additionally, the configuration of the outlet box 202, mounting flange 204, and base 206 can be adjusted to accommodate different electrical devices and wiring needs.

FIG. 13 shows an enlarged view of the outer portion of the base 206. In certain configurations, the base 206 includes a plurality of sidewalls 210 that at least partially define an interior. A front edge 212 of the base can include a channel 214 for receiving a gasket or a portion of a lid. A protrusion 216 can extend above the front edge 212 adjacent the channel 214. The protrusion 216 can extend along one or more sides of the base 206. In the illustrated embodiment, the protrusion 216 extends along at least a portion of all four sides of the base 206. The protrusion 216 can be continuous, discontinuous, or a combination of both. In certain configurations, the protrusion 216 can mate with a corresponding recess in a cover, or it can extend around an outer edge of the cover to act as a further barrier or ingress of rain or other elements.

The base 206 can provide an in-use housing for an outlet, and can have a depth sufficient to receive one or more plugs and the associated cords connected to the outlet. A portion of the front edge 212 can include a recessed groove 218 that allows one or more cords to pass outside of the housing when a lid is in a closed position. In certain configurations, a barrier channel 220 can be formed in the recessed groove 218 to receive a barrier 222. The barrier channel 220 can include a first end having a first keyed portion 224a and a second end with a second keyed portion 224b. The keyed portions can help retain the barrier 222 in the barrier channel 220.

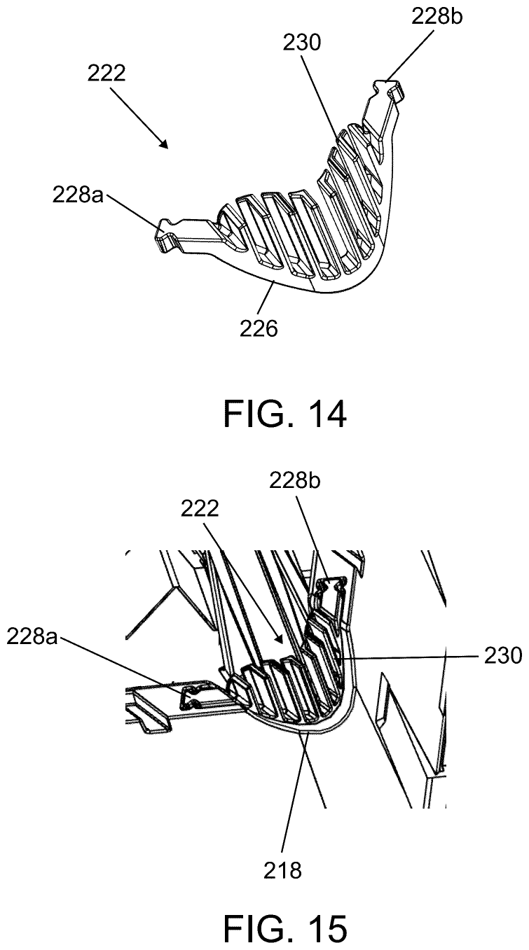

FIGS. 14 and 15 show an exemplary configuration of the barrier 222. The barrier includes a base 226 having a first keyed end 228a and a second keyed end 228b configured to mate with the keyed ends 224a, 224b in the barrier channel 220. The base 226 has a curved lower wall configured to follow the curve of the recessed groove 218. A plurality of fingers 230 extend from the base. The illustrated embodiment shows fingers 230 have an L-shaped configuration, although other shapes can be used. Other configurations can also have fewer or more fingers 230, and certain configurations can utilize a single seal element instead of fingers 230. The barrier 222 can be made of a flexible material, although the hardness of the material can be adjusted based on the required environmental and operational needs.

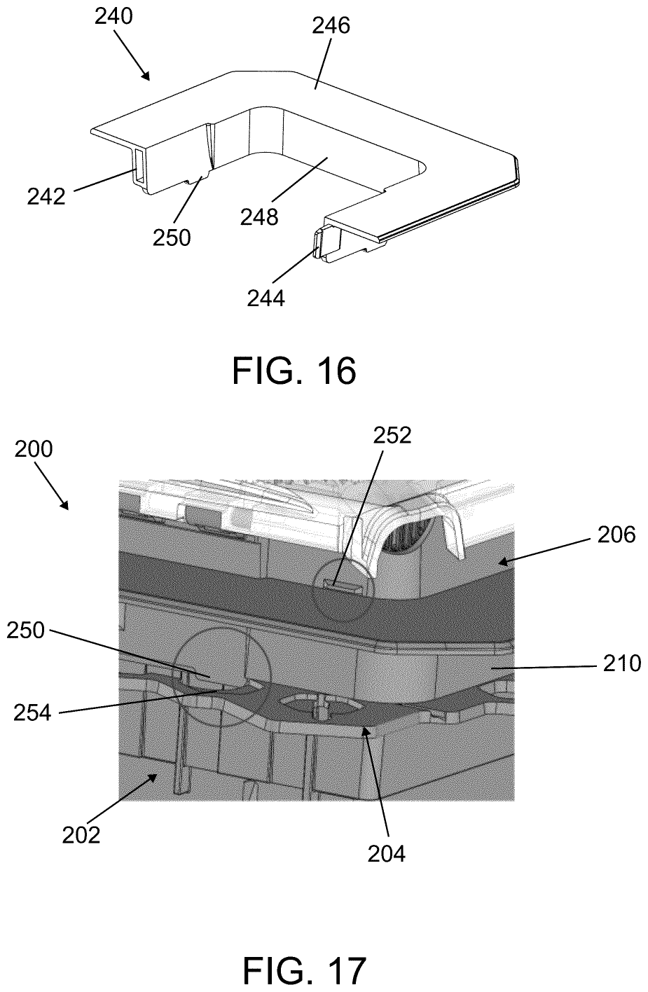

FIG. 16 shows an example of another configuration of siding flange 240 that can optionally be used with either the housing 100, 200, although it will be described with respect to the outlet housing 200 shown in FIG. 12. The siding flange 240 can be slidably engaged around the base 206 to provide a more flush appearance with siding on a wall. Although a single piece is shown, two mating pieces of the flange 240 are used together as previously described, locking together utilizing the slot 242 and the tab 244.

The combined siding flange 240 includes a first portion 246 extending in a first direction away from the outer walls 210 of the base 206. The first portion 246 includes an inner surface that is configured to face the support structure, such as a wall, and outer surface that is configured to face outwardly toward a user. The outer surface can be textured or colored as desired to match different types of housing sidings. The siding flange 240 includes a second portion 248 extending in a second direction away from the first portion 246. The second portion can be configured to be angled to correspond to the outer wall 210 of the base 206. In certain configurations one or more tabs 250 extend from the second portion 248 of the siding flange 240.

As shown in FIG. 17, the siding flange 240 can be connected around the base 206. One or more protrusion 252 can extend from the base 206 outer wall 210 to act as a front stop for the outer surface of the siding flange 240. The tabs 250 can be positioned in slots 254 formed in the mounting flange 204. Engagement with the outer edge of the slots 254 can prevent separation of the two flange pieces and help secure the siding flange 240 on the base 206.

Various components can be formed separately and provided as part of a kit to provide flexible installation options. In some implementations, two or more of the components can be integrally formed to reduce the number of parts and assembly required by the user. Accordingly, manufacture of these components separately or simultaneously may involve vacuum forming, injection molding, blow molding, casting, forging, cold rolling, milling, drilling, reaming, turning, grinding, stamping, pressing, cutting, bending, welding, soldering, hardening, riveting, punching, plating, and/or the like. Components manufactured separately may then be coupled or removably coupled with the other integral components in any manner, such as with adhesive, a weld joint, a solder joint, a fastener (e.g. a bolt and a nut, a screw, a rivet, a pin, and/or the like), washers, retainers, wrapping, wiring, any combination thereof, and/or the like for example, depending on, among other considerations, the particular material forming the components. For the exemplary purposes of this disclosure, the lid and base may be formed separately by an injection molding process, and then coupled together by a separate assembly step.

Different configurations of the components can be constructed from a wide variety of materials. For example, the components may be formed of: rubbers (synthetic and/or natural) and/or other like materials; glasses (such as fiberglass), carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, lead, iron, steel, carbon steel, alloy steel, tool steel, stainless steel, brass, tin, antimony, aluminum, any combination thereof, and/or other like materials; alloys, such as aluminum alloy, titanium alloy, magnesium alloy, copper alloy, any combination thereof, and/or other like materials; any other suitable material; and/or any combination of the foregoing thereof. Outlet boxes are typically made of metal or plastic. Metal junction boxes provide durability and help contain fires as they do not burn. They also offer better protection against physical impact and are often used in commercial and industrial settings. Plastic boxes can be made of PVC or other non-conductive materials, making them lightweight and easy to install. They are commonly used in residential settings where fire resistance is less critical. For the exemplary purposes of this disclosure, the housing 100 and lid 156 can be formed of a plastic material like a polyvinyl chloride (PVC).

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. A recessed outlet housing comprising:
an outlet box having a plurality of first side walls, a rear wall, and an open front configured to receive an electrical device;
a mounting flange extending from the outlet box, the mounting flange comprising a plurality of cells;
a base extending from the outlet box, the base having a plurality of second side walls, wherein the base is configured to receive a lid.

2. The recessed outlet housing of claim 1, wherein the plurality of cells include a first open cell and a first closed cell.

3. The recessed outlet housing of claim 1, wherein the plurality of cells have a hexagonal configuration.

4. The recessed outlet housing of claim 1, wherein the flange has a honeycomb configuration.

5. The recessed outlet housing of claim 1, wherein the flange includes a mounting slot configured to receive a fastener.

6. The recessed outlet housing of claim 1, wherein the flange is positioned between the outlet box and the base.

7. The recessed outlet housing of claim 1, further comprising a siding flange configured to be slidably positioned around the base.

8. A recessed outlet housing comprising:
an outlet box having a plurality of first side walls, a rear wall, and an open front configured to receive an electrical device;
a mounting flange extending from the outlet box, the mounting flange comprising a plurality of cells;
a base extending from the outlet box, the base having a plurality of second side walls; and
a lid movably connected to the base.

9. The recessed outlet housing of claim 8, wherein the plurality of cells include a first open cell and a first closed cell.

10. The recessed outlet housing of claim 8, wherein the plurality of cells have a hexagonal configuration.

11. The recessed outlet housing of claim 8, wherein the base has a cable groove to permit passage of a cable from an interior of the base to an exterior while the lid is in a closed position.

12. The recessed outlet housing of claim 11, wherein a barrier channel extends into the cable groove and a barrier is positioned in the barrier channel.

13. The recessed outlet housing of claim 12, wherein the barrier includes a finger.

14. The recessed outlet housing of claim 8, wherein the lid is biased to a closed position.

15. A recessed outlet housing comprising:
an outlet box having a plurality of first side walls, a rear wall, and an open front configured to receive an electrical device;
a mounting flange extending from the outlet box;
a base extending from the outlet box, the base having a plurality of second side walls;
a lid movably connected to the base; and
a siding flange removably connected to the base.

16. The recessed outlet of claim 15, wherein the siding flange includes a set of tabs that are configured to engage slots in the mounting flange.

17. The recessed outlet of claim 15, wherein the base includes a protrusion configured to limit movement of the siding flange.

18. The recessed outlet of claim 15, wherein the siding flange includes a first half releasably connected to a second half.

19. The recessed outlet of claim 18, wherein the first half is connected to the second half by a connecting tab extending from the first half mating with a first slot on the second half.

20. The recessed outlet of claim 15, wherein the mounting flange has a honeycomb configuration and includes a plurality of cells.
